(19) United States
(12) Patent Application Publication
(10) Pub. No.: US 2007/0106947 A1
(43) Pub. Date: May 10, 2007

(54) Method, system, and program product for selectively emphasizing a portion of a graphical display

(75) Inventors: Kent F. Hayes JR., Chapel Hill, NC (US); Steve Kim, Raleigh, NC (US); Paul F. McMahan, Apex, NC (US); Robert T. Uthe, Morrisville, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/269,008

(22) Filed: Nov. 8, 2005

(51) Int. Cl. G06F 17/00

(52) U.S. Cl. 715/744; 715/735

(57) ABSTRACT

The invention provides a method, system, and program product for selectively emphasizing a portion of a graphical display. In one embodiment, the method includes accessing at least one selection rule and applying the at least one selection rule to a graphical display.

### BACKGROUND OF THE INVENTION

1. Technical Field

The invention relates generally to the graphical display of data, and more particularly, to a method, system, and program product for selectively emphasizing a portion of a graphical display using at least one selection rule.

2. Description of the Related Art

Graphical displays are useful for representing relationships between two or more objects. Relationships may be shown as nodes, links, paths, and the like. Various systems management computer applications (e.g., IBM's Tivoli Business Systems Manager) use graphical displays, and specifically topology displays, to show paths that may be followed between individual components in a set of web services or information technology (IT) resources. However, relationships between individual components may be quite complex, particularly among web services or IT resources. Consequently, graphical displays depicting such relationships may be dense, busy-looking, and difficult for a user to understand or use. Such displays often include much more information than a user may require at any particular time.

One method for simplifying a complex graphical display is to selectively choose only certain components for display. This may be done, for example, by selecting a plurality of graphics representing such components using a computer mouse. This method suffers from a number of defects. First, it requires a user to navigate through what is often a very large display in order to select individual components. For example, relevant components may be displayed distant from each other due to the presence of intervening components and/or relationships, as well as the parameters of a particular graphical display. Second, it requires a user to have some knowledge of how the individual components are associated. That is, the graphical display itself generally does not include sufficient information regarding the relationships between components to enable a user to accurately select all relevant components for display.

Another method for simplifying a complex graphical display is to select only a portion of the display. Such a method is also insufficient, since, as noted above, relevant components may not be displayed near each other in a graphical display. As a result, relevant components may not be within the selected portion of the graphical display.

To this extent, a need exists for a method, system, and program product for quickly and accurately selecting components of a graphical display based on the properties of the components and/or the relationship(s) between the components.

### BRIEF SUMMARY OF THE INVENTION

The invention provides a method, system, and program product for selectively emphasizing a portion of a graphical display. In one embodiment, the method includes accessing at least one selection rule and applying the at least one selection rule to a graphical display.

A first aspect of the invention provides a method of selectively emphasizing a portion of a graphical display, the method comprising: accessing at least one selection rule; and applying the at least one selection rule to a graphical display.

A second aspect of the invention provides a system for selectively emphasizing a portion of a graphical display, the system comprising: a system for accessing at least one selection rule; and a system for applying the at least one selection rule to a graphical display.

A third aspect of the invention provides a program product stored on a computer-readable medium, which when executed, selectively emphasizes a portion of a graphical display, the program product comprising: program code for accessing at least one selection rule; and program code for applying the at least one selection rule to a graphical display.

A fourth aspect of the invention provides a method for deploying an application for selectively emphasizing a portion of a graphical display, comprising: providing a computer infrastructure being operable to: access at least one selection rule; and apply the at least one selection rule to a graphical display.

A fifth aspect of the invention provides computer software embodied in a propagated signal for selectively emphasizing a portion of a graphical display, the computer software comprising instructions to cause a computer system to perform the following functions: access at least one selection rule; and apply the at least one selection rule to a graphical display.

A sixth aspect of the invention provides a business method for selectively emphasizing a portion of a graphical display.

A seventh aspect of the invention provides a method of generating a system for selectively emphasizing a portion of a graphical display.

The illustrative aspects of the present invention are designed to solve the problems herein described and other problems not discussed, which are discoverable by a skilled artisan.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative graphical display, a portion of which may be selectively emphasized according to the invention.

FIG. 2 shows the graphical display of FIG. 1 including a menu of selection rules according to the invention.

FIGS. 3-7 show illustrative graphical displays, portions of which have been selectively emphasized according to the invention.

FIG. 8 shows an illustrative topology selection, a portion of which has been selectively emphasized according to the invention.

FIG. 9 shows a block diagram of an illustrative method according to the invention.

FIG. 10 shows an illustrative system for selectively emphasizing a portion of a graphical display according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system, and program product for selectively emphasizing a portion of a graphical display.

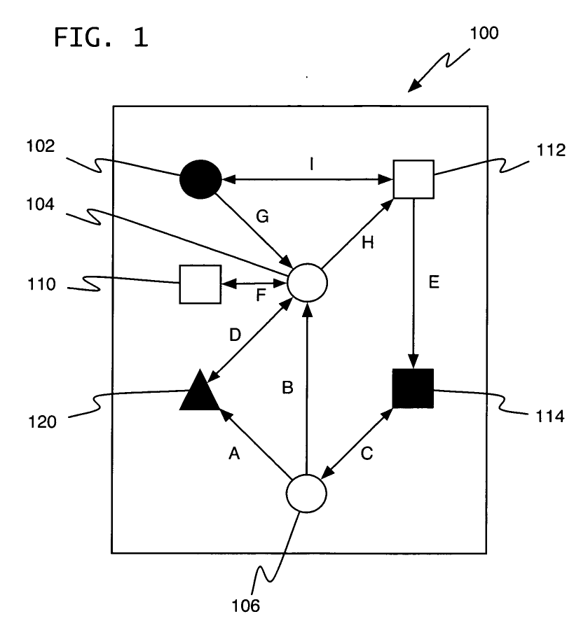

Turning to the drawings, FIG. 1 shows a graphical display 100, a portion of which may be selectively emphasized according to the invention. Graphical display 100 depicts relationships between individual components 102, 104, 106, 110, 112, 114, 120. Individual components may be of various and differing types. For example, in the case that graphical display 100 depicts relationships among IT resources, individual components may include, for example, computer workstations, servers, routers, printers, etc. For purposes of simplicity, differing components are shown having differing shapes (i.e., circular, square, and triangular) and colors (i.e., black and white). These may represent different types of devices, the operating system(s) of the device(s), the availability of the device(s), etc. Relationships A-I between pairs of individual components may similarly vary. For example, some relationships may be bidirectional (e.g., C, D, F, I) or unidirectional (e.g., A, B, E, G, H). Relationships may similarly represent methods of communication (e.g., wireless, wired, encrypted, nonencrypted, etc.) or other characteristics of the relationship(s) between individual components.

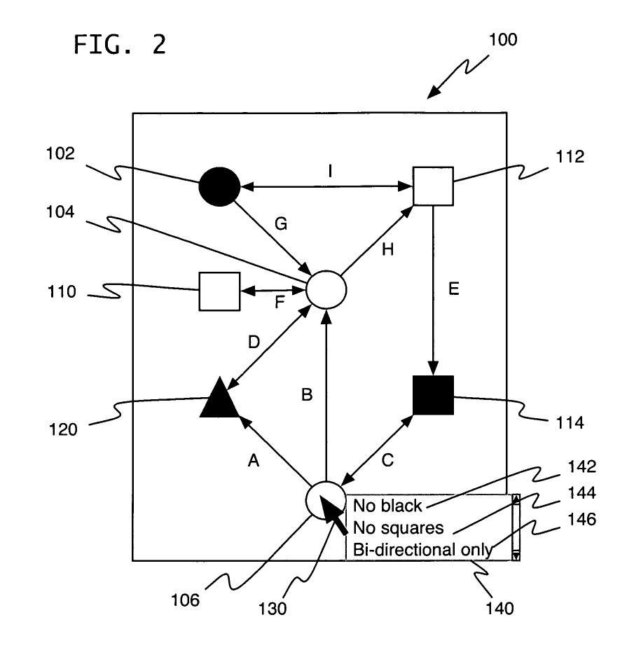

Referring now to FIG. 2, a menu 140 of selection rules 142, 144, 146 may be accessed by, for example, positioning a mouse pointer 130 adjacent a component 106 and executing a keystroke (e.g., “control clicking” or “right clicking”). Other methods for accessing menu 140 will be known to one of ordinary skill in the art. One or more selection rules 142, 144, 146 may be employed to selectively emphasize a portion of graphical display 100. Selectively emphasizing a portion of graphical display 100 may include, for example, removing components not meeting a criterion of the selection rule 142, 144, 146, highlighting components meeting such a criterion, or any other method of distinguishing components that meet a criterion of the selection rule from components not meeting the criterion.

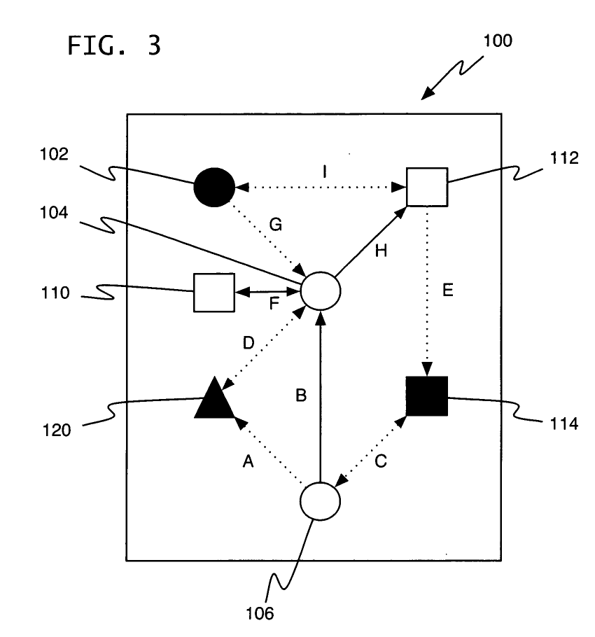

For example, FIG. 3 shows graphical display 100 following selection of the “No black” selection rule 142 (FIG. 2). As shown in FIG. 3, only components not colored black are shown as accessible to component 106. As such, all relationships to black colored components 102, 114, 120 are shown as broken lines. That is, relationships A, C, D, E, G, and I are shown as unavailable to component 106, either directly or through another component, because each of relationships A, C, D, E, G, and I is connected to a black colored component 102, 114, 120.

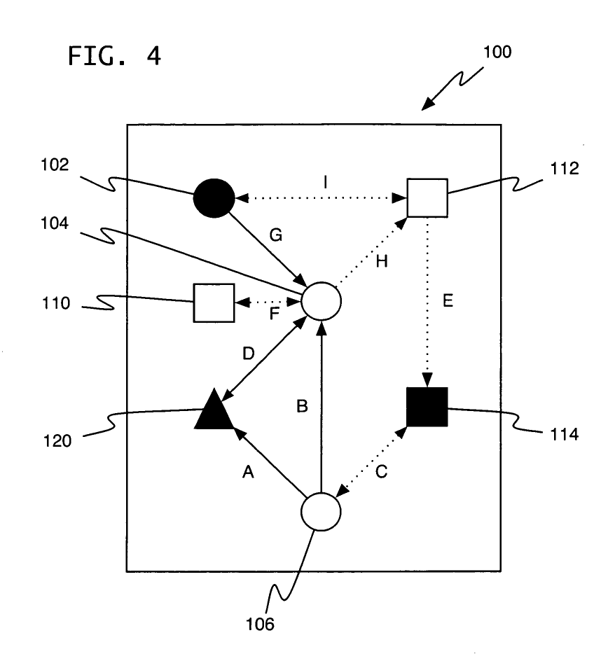

FIG. 4 shows the graphical display 100 after selection of the “No squares” selection rule 144 (FIG. 2). That is, each of relationships C, E, F, H, and I are shown as broken lines because each is connected to a square component 110, 112, 114.

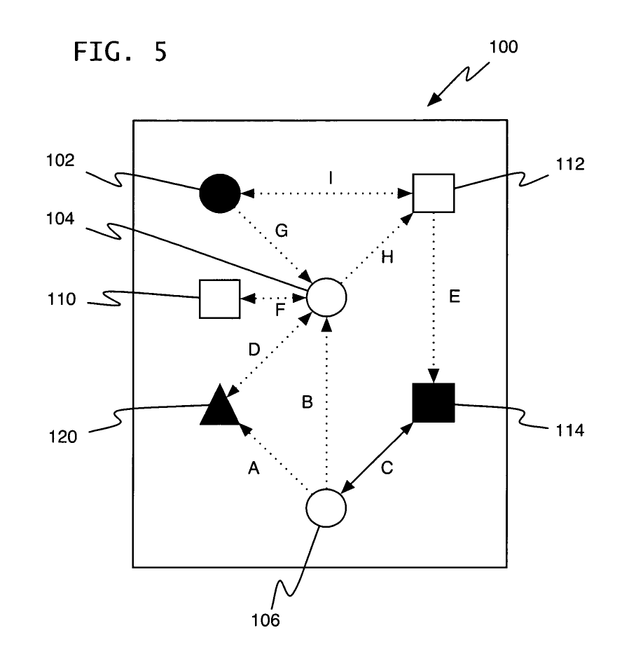

FIG. 5 shows the graphical display 100 after selection of the “Bi-directional only” selection rule 146 (FIG. 2). As shown in FIG. 5, each of relationships A, B, D, E, F, G, H, and I is shown as a broken line. It should be noted that each of relationships D, F, and I are shown as a broken line, even though the relationship is bidirectional, because the components connected by these relationships are not available to component 106. That is, none of relationships D, F, or I is connected to a component that is otherwise connected to component 106, either directly or through another component. In fact, only relationship C meets the criterion of “Bi-directional only” selection rule 146 (FIG. 2), as applied to component 106. Accordingly, only component 114 is available to component 106.

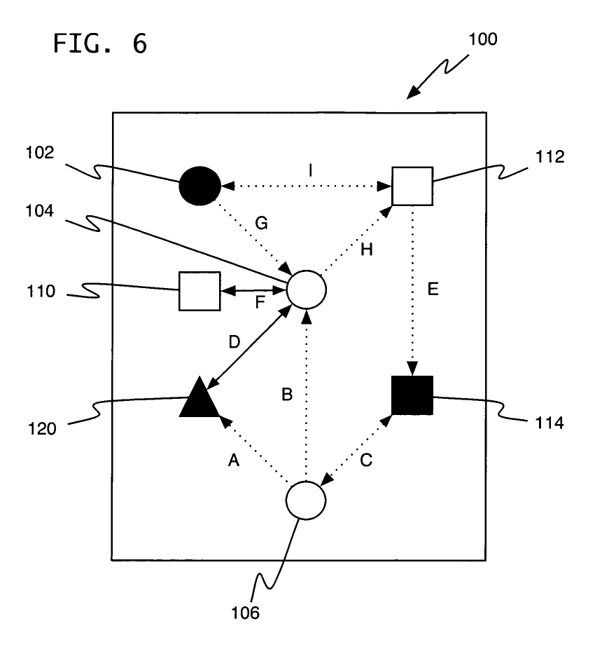

Of course, if the same “Bi-directional only” selection rule 146 (FIG. 2) is applied to a different component, the results may be different. For example, FIG. 6 shows the graphical display 100 in the case that the “Bi-directional only” selection rule 146 (FIG. 2) is applied to component 110. As shown in FIG. 6, components 104 and 120 are available to component 110 through bidirectional relationships F and D, respectively.

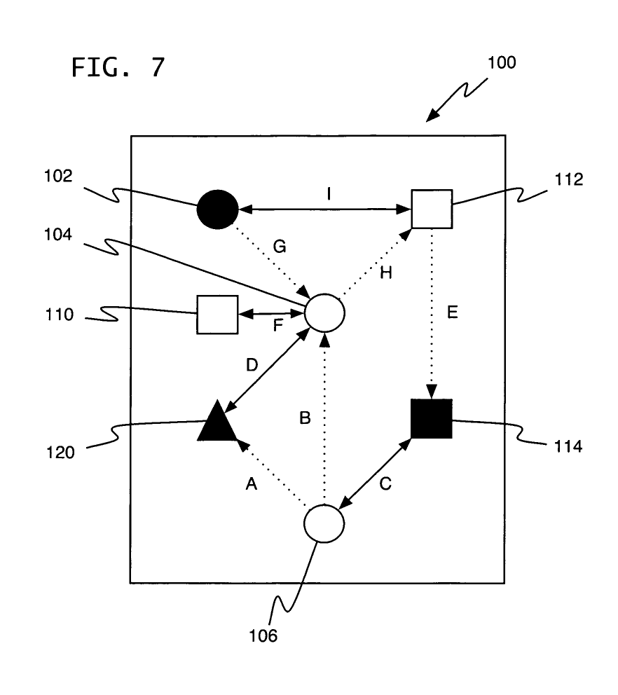

Alternatively, a selection rule may be applied to graphical display 100 as a whole rather than relative to a particular component, as in FIGS. 2-6. For example, FIG. 7 shows the graphical display 100 in the case that the “Bi-directional only” selection rule 146 (FIG. 2) is applied to the graphical display 100 as a whole. As shown in FIG. 7, only unidirectional relationships A, B, E, G, and H are shown as broken lines. That is, each of relationships C, D, F, and I satisfy the “Bi-directional only” criterion of the “Bi-directional only” selection rule 146 (FIG. 2), making available each of components 102, 104, 106, 110, 112, 114, and 120 through one or more other component.

Whether a selection rule is applied relative to a graphical display as a whole or to a particular component or components of the graphical display, the emphasized portion of the graphical display may then be employed in the execution of any operational, administrative, maintenance, or other task for which a graphical display may be employed. For example, still referring to FIG. 7, a user may choose, for example, to access, change, or modify the function or status of one or more components or the relationship(s) between components after applying selection rule 146 (FIG. 2). That is, where a graphical display, such as a topology display, may be utilized in performing tasks associated with the displayed components, a portion of a graphical display selectively emphasized according to the present invention may similarly be employed in performing such tasks. In fact, a portion of a graphical display selectively emphasized according to the present invention may simplify such tasks by simplifying the graphical display available to a user.

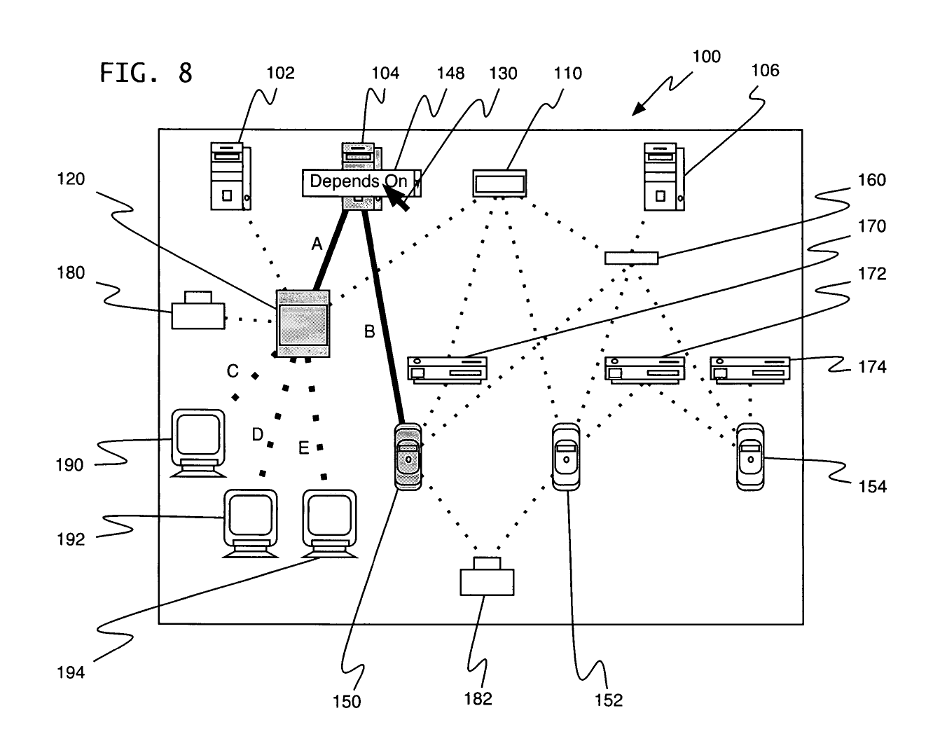

For example, referring now to FIG. 8, a topology display 100 is shown comprising various information technology (IT) resources. Such resources may include, for example, application servers 102, 104, 106, external storage devices 110, mainframe computers 120, mainframe workstations 190, 192, 194, desktop computers 150, 152, 154, network routers/hubs/switches 160, file servers 170, 172, 174, and networked or shared printers 180, 182.

Topology display 100 is illustrative of a display that may be presented to a systems administrator responsible for performing certain maintenance or other tasks associated with IT resources. For example, an administrator may find it necessary to perform a maintenance task on application server 104. Such a task may affect the performance or availability of application server 104. Accordingly, the administrator may wish to identify other IT resources, relationships, paths, nodes, etc. whose operation, availability, or functionality depend, directly or indirectly, on application server 104. In such a case, it may be desirable for the administrator to take each affected or potentially affected IT resource “off line” by, for example, placing each in a maintenance mode. An administrator may do so according to the invention by first accessing and applying a “depends on” selection rule 148 to application server 104. As described above, selection rule 148 may be accessed and/or applied using a mouse pointer 130 or other method or device.

Selection rule 148 may be adapted, for example, to selectively emphasizing a portion of topology display 100 to show IT resources that depend directly or indirectly upon application server 104. Similarly, selection rule 148 may be adapted, for example, to identify IT resources that will not function without application server 104, IT resources whose availability to a user or other IT resource will be affected without application server 104, or IT resources whose functionality or operation will be affected without application server 104. For example, upon application of selection rule 148 to application server 104, mainframe computer 120 and desktop computer 150 are identified as directly depending upon application server 104 by shading each dark grey and displaying their respective paths (A and B) to application server 104 as bold, unbroken lines. IT resources whose functionalities depend indirectly upon application server 104 may similarly be emphasized. For example, in FIG. 8, the functionalities of mainframe workstations 190, 192, 194 depend upon mainframe computer 120, which, as explained above, depends upon application server 104. Accordingly, mainframe workstations 190, 192, 194 are shown in light grey and their respective paths, C, D, and E, to mainframe computer 120 are shown as bold, broken lines. Emphasizing a portion of topology display 100 to show such direct and indirect dependencies may be done simultaneously, additively, or alternately, as will be recognized by one having skill in the art.

As described above, upon emphasizing a portion of topology display 100 as in FIG. 8, an administrator may then choose to execute a task based upon the emphasized portion of the display. For example, an administrator may choose to place each of application server 104, mainframe computer 120, and desktop computer 150 in a maintenance mode. Of course, an administrator may also decide not to execute such a task, based upon the emphasized portion of the display. For example, if the administrator was aware, by virtue of topology display 100 or otherwise, that mainframe workstation 190 was currently being used to execute a task using an application from application server 104, the administrator may decide not to perform the maintenance task on application server 104, as doing so may affect the task being executed by mainframe workstation 190. However, without the benefit of a topology display 100, a portion of which is emphasized according to the present invention, the indirect dependency of mainframe workstation 190 upon application server 104 may not be knowable to the administrator.

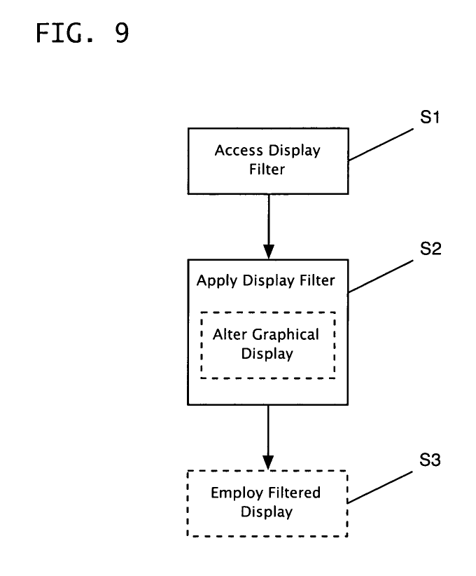

FIG. 9 shows a block diagram of an illustrative method according to the invention. First, at step S1, a selection rule, e.g., 142 (FIG. 2) is accessed, as explained above. Next, at step S2, the selection rule accessed at step S1 is applied to a graphical display 100 (FIG. 3) as a whole or a component or components within the graphical display, whereby a portion of the graphical display is emphasized based on the selection rule. At optional step S3, the graphical display may then be employed in the performance of an operational, administrative, or other task, as described above.

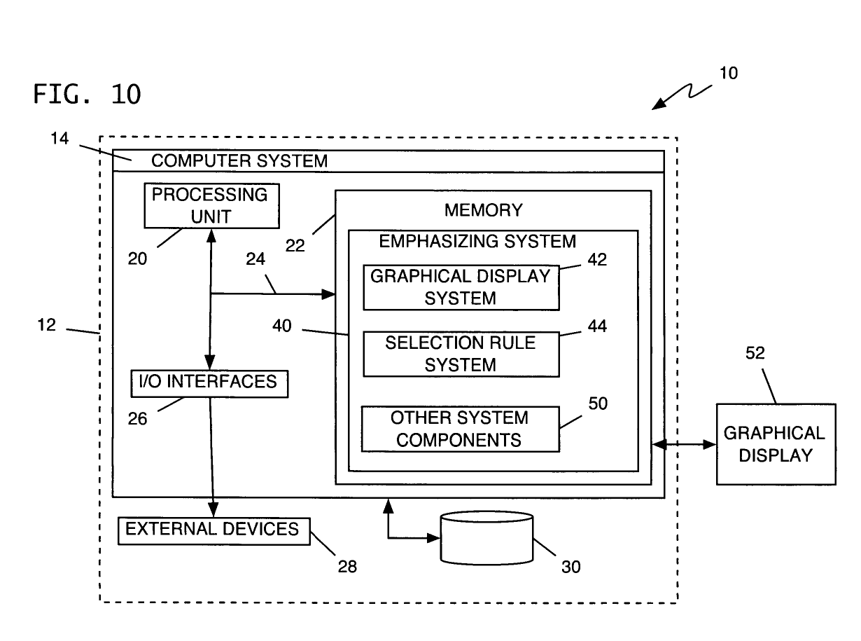

FIG. 10 shows an illustrative system 10 for selectively emphasizing a portion of a graphical display. To this extent, system 10 includes a computer infrastructure 12 that can perform the various process steps described herein for selectively emphasizing a portion of a graphical display. In particular, computer infrastructure 12 is shown including a computer system 14 that comprises an emphasizing system 40, which enables computer system 14 to selectively emphasize a portion of a graphical display by performing the process steps of the invention.

Computer system 14 is shown including a processing unit 20, a memory 22, input/output (I/O) interfaces 26, and a bus 24. Further, computer system 14 is shown in communication with external I/O devices/resources 28 and a storage system 30. As is known in the art, in general, processing unit 20 executes computer program code, such as emphasizing system 40, that is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices that enable a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and emphasizing system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, emphasizing system 40 enables computer system 14 to selectively emphasize a portion of a graphical display. To this extent, emphasizing system 40 is shown including a graphical display system 42 and a selection rule system 44. Operation of each of these systems is discussed above. Emphasizing system 40 may further include other system components 50 to provide additional functionality to emphasizing system 40. As mentioned above, such components may include, for example, operational or administrative systems with which a graphical display may be employed. However, it is understood that some of the various systems shown in FIG. 9 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for selectively emphasizing a portion of a graphical display, it is understood that the invention further provides various alternative embodiments. For example, in one embodiment, the invention provides a computer-readable medium that includes computer program code to enable a computer infrastructure to selectively emphasize a portion of a graphical display. To this extent, the computer-readable medium includes program code, such as emphasizing system 40, that implements-each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to selectively emphasize a portion of a graphical display as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for selectively emphasizing a portion of a graphical display. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of selectively emphasizing a portion of a graphical display, the method comprising:
accessing at least one selection rule; and
applying the at least one selection rule to a graphical display.

2. The method of claim 1, wherein applying includes altering at least one of the graphical display and a component of the graphical display based on a criterion of the at least one selection rule.

3. The method of claim 1, wherein the graphical display includes at least two components and at least one of a relationship and a path between the at least two components.

4. The method of claim 3, wherein applying includes altering at least one of the relationship and the path between the at least two components.

5. The method of claim 1, further comprising employing the graphical display in the execution of a task.

6. The method of claim 5, wherein the task includes at least one of an operational task, an administrative task, and a maintenance task.

7. The method of claim 5, wherein the task includes at least one of accessing, changing, and modifying at least one of a function and a status of at least one of a component of the graphical display, a relationship between two components of the graphical display, and a path between two components of the graphical display.

8. The method of claim 1, wherein the graphical display is a topology display.

9. A system for selectively emphasizing a portion of a graphical display, the system comprising:
a system for accessing at least one selection rule; and
a system for applying the at least one selection rule to a graphical display.

10. The system of claim 9, wherein the system for applying includes means for altering at least one of the graphical display and a component of the graphical display based on a criterion of the at least one selection rule.

11. The system of claim 9, wherein the system for applying includes means for altering at least one of a relationship and a path between at least two components of the graphical display.

12. The system of claim 9, further comprising a system for employing the graphical display in the execution of a task.

13. The system of claim 12, wherein the system for employing includes means for at least one of accessing, changing, and modifying at least one of a function and a status of at least one of a component of the graphical display, a relationship between two components of the graphical display, and a path between two components of the graphical display.

14. A program product stored on a computer-readable medium, which when executed, selectively emphasizes a portion of a graphical display, the program product comprising:
program code for accessing at least one selection rule; and
program code for applying the at least one selection rule to a graphical display.

15. The program product of claim 14, further comprising program code for altering at least one of the graphical display and a component of the graphical display based on a criterion of the at least one selection rule.

16. The program product of claim 14, further comprising program code for altering at least one of a relationship and a path between at least two components of the graphical display.

17. The program product of claim 14, further comprising program code for employing the graphical display in the execution of a task.

18. The program product of claim 14, further comprising program code for at least one of accessing, changing, and modifying at least one of a function and a status of at least one of a component of the graphical display, a relationship between two components of the graphical display, and a path between two components of the graphical display.

19. A method for deploying an application for selectively emphasizing a portion of a graphical display, comprising:
providing a computer infrastructure being operable to:
access at least one selection rule; and
apply the at least one selection rule to a graphical display.

20. The method of claim 19, wherein applying includes altering at least one of the graphical display and a component of the graphical display based on a criterion of the at least one selection rule.
